(19) United States
(12) Patent Application Publication
(10) Pub. No.: US 2009/0083099 A1
(43) Pub. Date: Mar. 26, 2009

(54) Online interactive website for the jewelry industry

(76) Inventor: Al Fetanat, Irvine, CA (US)

Correspondence Address: Morland C. Fischer, Suite 1300, 2030 Main Street, Irvine, CA, 92614, US

(21) Appl. No.: 11/904,055

(22) Filed: Sep. 26, 2007

(51) Int. Cl. G06Q 30/00; G06F 17/30; G06Q 50/00; G06Q 10/00

(52) U.S. Cl. 705/7; 707/3; 707/E17.014

(57) ABSTRACT

An online network including an interactive website by which to enable jewelers and others associated with the jewelry industry to quickly and easily conduct searches from a desktop computer to enhance their business. According to a preferred embodiment, the online searches that may be conducted at the website relate to the location and availability of a particular gemstone (e.g., a diamond), the wholesale value of a particular gemstone, and a schedule of events applicable to those in the jewelry industry. A jeweler visits the website and enters on his computer the details of a gemstone of interest or an event to be attended. An automated search of a database stored on an affiliated server is conducted and the results are reported to the jeweler so that appropriate action can be taken concerning the stone or event.

### BACKGROUND OF THE INVENTION

1. Field of the Invention

This invention relates to an online network including an interactive website that is specifically tailored to jewelers and others in the jewelry industry by which searches can be conducted from a desktop computer regarding the location and availability of particular gemstones (e.g., diamonds) of interest, the wholesale value of a particular gemstone, and details regarding a schedule of events offered to those in the jewelry profession.

2. Background Art

The jewelry industry is a worldwide business which impacts wholesalers, brokers, buyers, importers, retailers and their customers. However, no easily accessible centralized repository of information is known to be currently available to those in the business at any time and from any location. Therefore, one seeking to locate a particular gemstone may only be able to conduct a limited search among nearby sources of supply. Moreover, the search for the gemstone of interest may require the searcher to personally contact one potential source after another. Consequently, such a search will likely be time consuming and tedious. In fact, a significant time may already be wasted before the searcher finally realizes that the gemstone of interest is not available to him from any of the sources encountered during his search.

In some cases, one in the jewelry business may wish to learn the wholesale or replacement value of a particular gemstone having particular characteristics. Once again, because no centralized, easily accessible repository of wholesale price information is known which is currently available to the industry, a time-consuming investigation may be required in order to obtain up-to-date and reliable information. Notwithstanding the foregoing, the wholesale price data may not be uniform from one location to the next. That is to say, a search may produce widely different values for the same gemstone when the price information is collected in different countries or in different regions of the same country. Such inconsistent pricing may have a negative impact on those whose business requires frequent travel for buying and selling precious gemstones.

What is even more, jewelers and others in the industry may wish to have ready access to a schedule of upcoming professional programs, seminars, meetings and similar events. However, there is no currently known source of information that can be accessed from any place in the world to enable the searcher to gather information about such professional gatherings so that an orderly investigation can be conducted as to the subject matter, location and date thereof.

Accordingly, what is needed by those in the jewelry business is a means to overcome the lack of readily available and up-to-date information concerning the industry by having easily accessible, current and reliable information which allows jewelers and other professionals around the world to locate a particular gemstone of interest, secure an appraisal (i.e., the wholesale value) of a particular gemstone, and review information concerning programs offered to the profession so that a decision can be made whether to attend.

### SUMMARY OF THE INVENTION

To overcome the shortcomings described above, a website is now available having particular application to the jewelry profession at which jewelry-specific information that is stored on a server affiliated with the website can be accessed by jewelers regardless of their location. Certain information stored in a database on the server relates to the availability and location of particular gemstones such as, but not limited to, diamonds. The corresponding information is uploaded to the site by a variety of owner/vendors having an inventory of available stones. A jeweler wishing to search for a specific gemstone to fill his needs or those of a customer first visits the website and enters the characteristics (e.g., weight, shape, color, clarity, etc.) of the stone of interest. An automated search of the database stored on the server is conducted to identify any stones having characteristics that match the search criteria entered by the jeweler/searcher. If no matching stones are identified in the database, then a corresponding message is displayed. The jeweler/searcher may then either revise the search field and conduct a new search or simply end the search. If at least one matching stone is otherwise identified, the jeweler/searcher is given the ability to open a link through the website to any website of the owner/vendor or, if the owner/vendor is online, to start a dialog. In this manner, the jeweler/searcher can learn more about the owner/vendor and the designated gemstone listed in the database so that a purchase might be arranged.

A jeweler or other member of the profession may also visit the website to search through and review a schedule of professional programs, seminars, and meetings that might be of interest. In this case, the jeweler/searcher clicks on a header link or a recognizable image or logo that is displayed at the site and associated with an event from the schedule of events listed in a database and stored on the affiliated server. The event information is initially uploaded to the website by event organizers and sponsors. The jeweler/searcher is then linked through the website to any website associated with the event whose header, image or logo is displayed so that details concerning the event can be reviewed. In the alternative, the jeweler/searcher can click an autoplay button to move sequentially forward or back through the schedule of events being showcased at the website.

Occasionally, the jeweler and other members of the profession are in need of a prompt and accurate appraisal concerning the wholesale (i.e., replacement) value of a gemstone. Once the jeweler visits the website, he may search in real time through a database stored on the affiliated server for an appraisal depending upon the characteristics (e.g., weight, shape, color, clarity, etc.) of the stone of interest. Known prices derived from prior purchases and sales of gemstones in the wholesale market are regularly uploaded to the site by those in the jewelry business to be listed in the database according to weight. The jeweler wishing to search for a specific wholesale value enters the characteristics of the gemstone of interest. An automated search of the database is conducted to identify any stones in a particular weight range having the other characteristics that match the search criteria. If no matching stones are identified in the designated weight range, a corresponding message is displayed. On the other hand, if stones listed in the database match the search criteria, the average wholesale price is computed for all matching stones in the designated weight range. The computed average price is then multiplied by the actual weight (e.g., in carats) of the gemstone of interest and the resultant wholesale price is displayed to the jeweler/searcher. A printout, if desired, may also be provided for the jeweler.

### BRIEF DESCRIPTION OF THE DRAWINGS

FIG. 1 is illustrative of one page of a website that is tailored to jewelers and others in the jewelry business, whereby a visitor to the site can conduct a search from his desktop computer to locate a gemstone (e.g., a diamond) having particular characteristics;

FIG. 2 is illustrative of a different page of the website at which a visitor is able to search through a schedule of professional events and link through the site to the event organizer or sponsor so that details concerning the event can be obtained;

FIG. 3 is illustrative of yet another page of the website at which a visitor is able to obtain a fast and reliable appraisal of the wholesale value of a gemstone having particular characteristics;

FIG. 4 illustrates the steps performed by means of downloadable software to enable a visitor to the website at the page shown in FIG. 1 to locate a particular gemstone;

FIG. 5 illustrates the steps performed by means of software to enable a visitor to the website at the page shown in FIG. 2 to learn details of an event from a schedule of events; and

FIG. 6 illustrates the steps performed by means of software by which a visitor to the website at the page shown in FIG. 3 obtains an appraisal of the wholesale value of a particular gemstone.

### DESCRIPTION OF THE PREFERRED EMBODIMENT

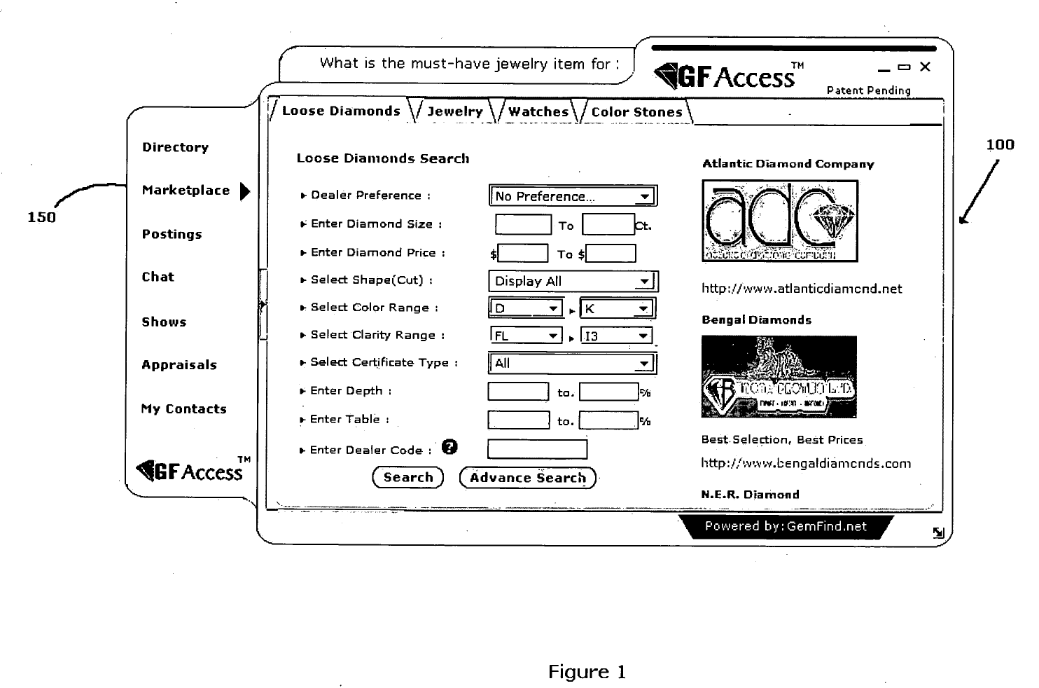

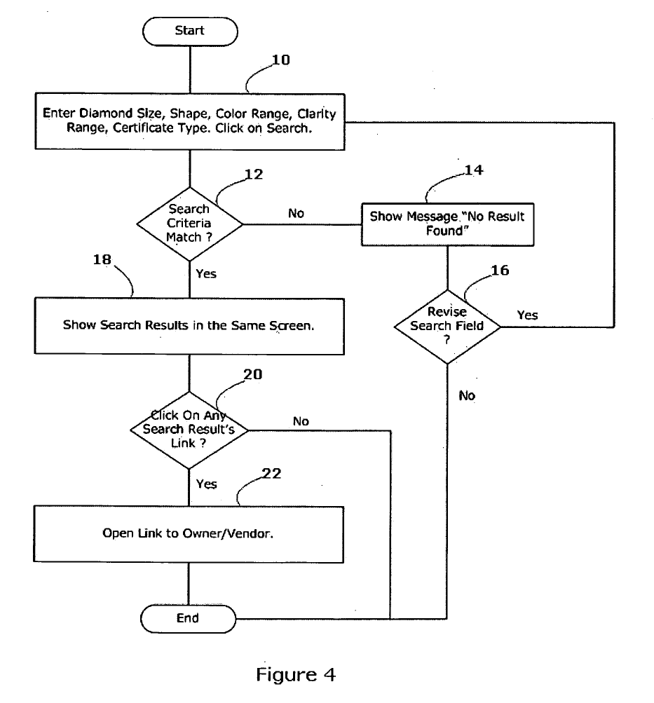

FIGS. 1-3 of the drawings illustrate different pages of a website that is part of an online network specifically tailored to jewelers and others in the jewelry industry by which jewelry professionals can use a desktop or similar computer to search and access information about their trade. The information to be accessed is listed in one or more databases stored on a server that is affiliated with the website. So that the information to be accessed is both current and reliable, the search data is supplied (i.e., uploaded to the site) by those in the jewelry business who are likely to need such information. For example, the jewelry related information which forms the basis for the online searches available at the website herein described will typically be provided by jewelers, wholesalers, site holders, importers, and the like. The search process is controlled by downloadable software (represented by FIGS. 4-6) that preferably resides on the search requester's computer.

Referring in this regard to FIG. 1, there is shown a page 100 of the website by which a jeweler/search requester who visits the site can initiate a search 150 to find the availability and location of a particular gemstone (in this case, a loose diamond). As will be described in greater detail when referring to FIG. 4, the site enables the jeweler/requester to enter the specific characteristics of the gemstone which is the object of his/her search. The result of searching the data stored on the affiliated server will alert the jeweler/requester to any gemstones which conform to the search criteria and are available from those, regardless of location, who have uploaded their inventory information to the website.

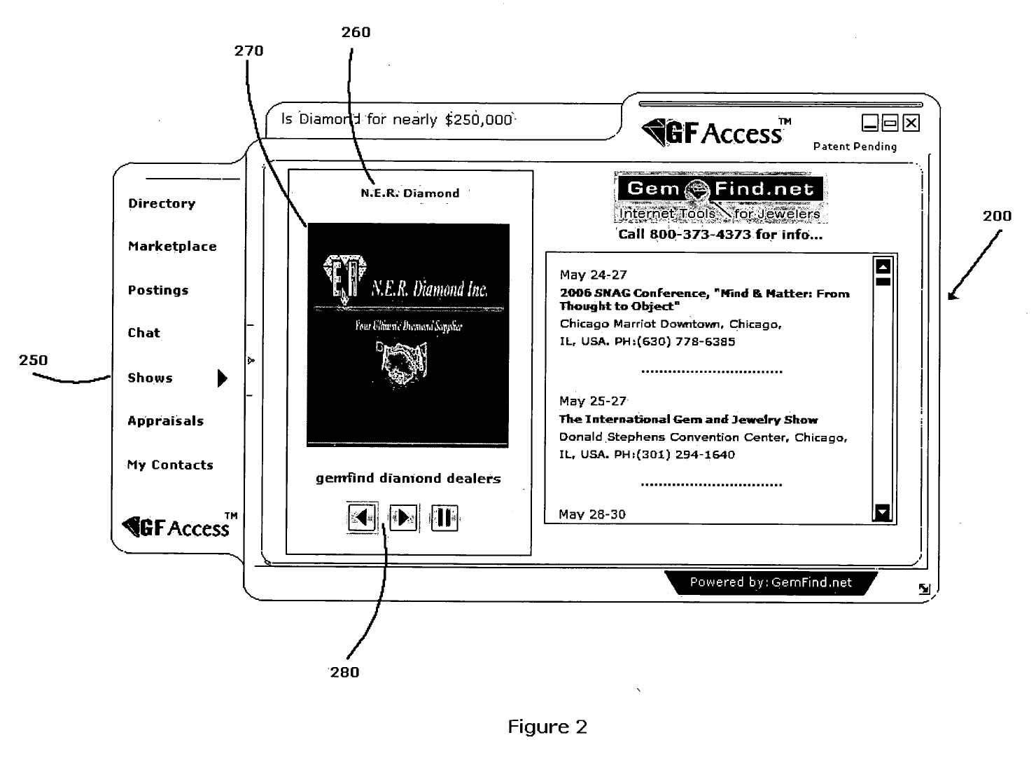

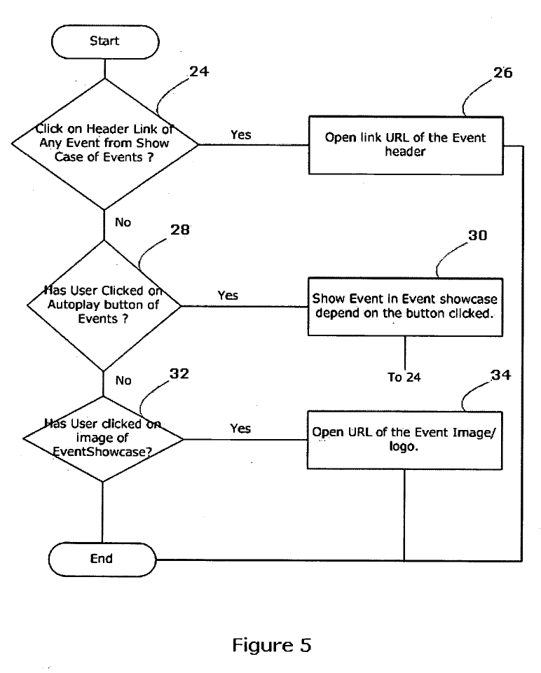

FIG. 2 is illustrative of another page 200 of the jewelry related website by which a jeweler/search requester who visits the site can initiate a search 250 through a schedule of professional events to learn details of the events so that a decision can be made whether to attend. As will be described in greater detail when referring to FIG. 5, the website provides the jeweler/search requester with the ability to access information by, for example, clicking on a header 260 or an image or logo 270 that is representative of each event. In addition, the jeweler/requester may activate an autoplay feature 280 of the site to move sequentially back and forth through all of the events listed in the schedule in order to pick and choose the events which are of greatest interest.

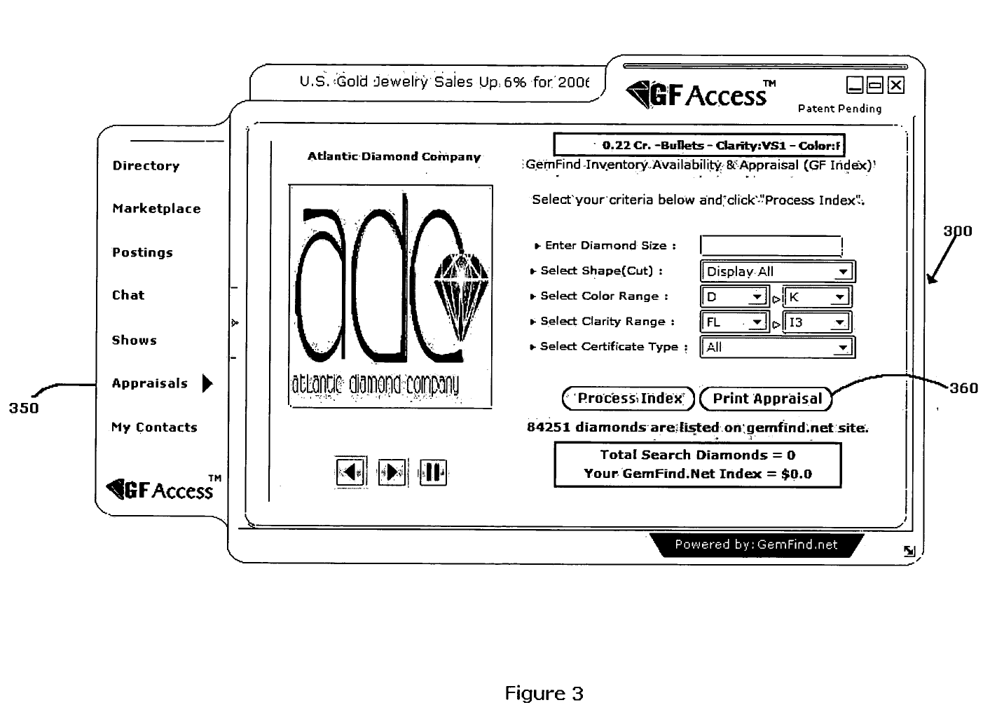

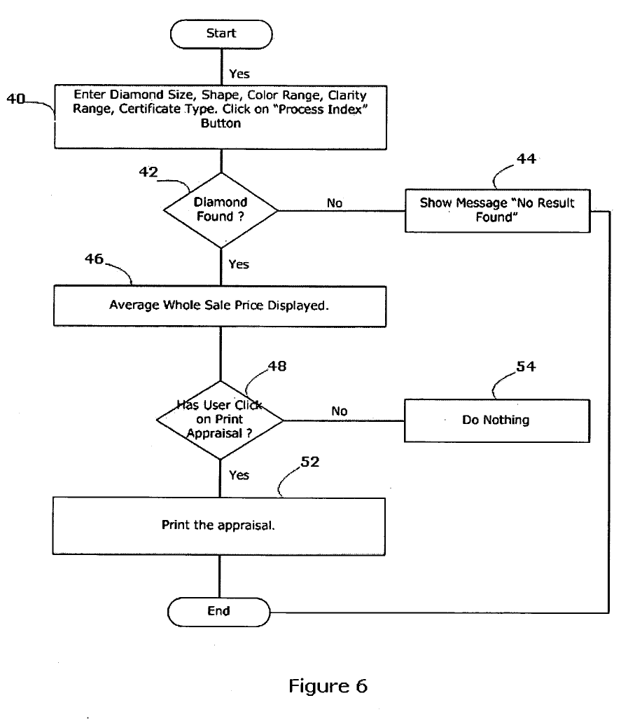

FIG. 3 is illustrative of a different page 300 of the website by which a jeweler/search requester who visits the site can initiate a search 350 to obtain an accurate appraisal of the wholesale (i.e., replacement) value of a particular gemstone (in this case, a loose diamond) based upon recent price information that has been uploaded to the site. As will be described in greater detail when referring to FIG. 6, the site enables the jeweler/requester to enter specific characteristics of the stone which is the object of his/her search. The result of searching the price data stored on the affiliated server is a display (not shown) of the current wholesale price provided that gemstones have been purchased or sold in the wholesale market in the past which conform to the search criteria entered at the site. The website also enables the jeweler to obtain a printout 360 of the appraisal.

Referring to FIG. 4 of the drawings, there is shown a representation of the steps by which a jeweler or another member of the jewelry profession (i.e., the search requester) performs an automated search of information that is made available to him at a website in the manner shown at FIG. 1 in order to help the jeweler determine the availability and location of a particular gemstone, such as a loose diamond, or the like. Finding a particular gemstone in an efficient manner can be important to those in the jewelry business so as to satisfy their business needs and/or the needs of their customers. Once the jeweler/search requester accesses the website, he (or she) enters the characteristics 10 of the gemstone which is the subject of the search. Such characteristics may include, for example, the size or weight, shape, color and clarity of the stone as well as the certificate type, if any. Any one or more of the aforementioned search criteria are entered by clicking or pressing a touch screen showing corresponding ranges at the website as shown, for example, in FIG. 1.

Once the characteristics of the gemstone are identified, the jeweler/requester initiates a search 12 of available gemstones from a database that is stored on the affiliated server. The scope of the search will depend upon the search field which is initially selected concerning the gemstone of interest. In the event a search of the database does not identify any gemstone having all of the characteristics which match the search criteria, a suitable message is displayed 14 to the jeweler/requester and the search is ended. If desired, the jeweler/requester may wish to change the original search criteria 16 and perform a new search in order to locate an available gemstone corresponding to the revised search field.

In the event that gemstone characteristics in the database match the search field entered by the jeweler/requester, information concerning the available gemstone(s) is displayed 18 adjacent the original search criteria. In this case, the search results (not shown) displayed to the jeweler/requester will list the contact information for the owner/vendor of each appropriate stone that is located in the database. Such contact information may include the name of each gemstone owner/vendor, his (or her) postal and e-mail addresses and telephone number, as well as the precise characteristics of the stone and the wholesale price thereof.

If the information displayed also includes a link to a website, the jeweler/requester is provided with the option 20 of going directly to such website to learn more about the owner/vendor of each identified gemstone and the nature of his business. The search conducted by the jeweler/requester will now end if the owner/vendor of the gemstone has no website or the jeweler/requester does not wish to visit a website. However, if the jeweler/requester otherwise clicks on the website, he will be linked to that site so as to access background information regarding the owner/vendor. Moreover, the jeweler may also wish to open a link 22 through the website by which to either send an e-mail to the owner/vendor of the identified gemstone or, if the owner/vendor is online, start a dialog. The search is then ended at which time the search data discovered can be used by the jeweler/requester as is necessary for his business.

The jeweler/requester may also use the website to search for information initially uploaded to the website by event organizers or sponsors concerning local, national and international trade shows, seminars, conferences, and the like, which relate to gemology or other professional subjects of interest. In this regard, and referring now to FIG. 5, the website will display a schedule of events in the manner shown in FIG. 2, any one or more of which may be of interest to the jeweler. Should the jeweler click on or touch activate 24 a header (designated 260 in FIG. 2) corresponding to an event from the schedule of events, a link is opened 26 directly to the event website. In this manner, the jeweler can quickly and easily learn detailed information about the event so that a decision might be made whether to attend.

Provided that the jeweler is only interested in gaining information about a single event from the schedule of events showcased at the website, his search for such information will end. However, it may be that the jeweler wishes to learn information about more than just one event. Accordingly, the website visited by the jeweler has an autoplay feature (280 in FIG. 2) that is associated with the complete schedule of upcoming events. More particularly, the jeweler simply clicks or touch activates 28 a “Previous” or “Next” button. Depending upon the button activated, the identity and a brief description of the corresponding event will be displayed 30 for perusal by the jeweler. In this manner, the jeweler quickly and easily moves sequentially back and forth through the schedule of events. Should any event prove to be of interest, the jeweler may complete steps 24 and 26 one or more times by clicking on the header links (if available) of the particular event(s) of interest from the schedule of events that are displayed at the website visited by the jeweler.

For simplicity, instead of completing step 24 and clicking or touch activating the header links associated with different events from the schedule of events, the jeweler may wish to click or touch activate 32 an image or logo (270 in FIG. 2) that is known to jewelers as being associated with certain events and/or their sponsors. To this end, the website will display the respective images and logos which identify the events/sponsors. If the jeweler chooses a particular image or logo, then, as in the case of step 26, a link is opened 34 directly to the selected event website. If no image or logo has been chosen, the jeweler's search for event information will end. If an image or logo has otherwise been chosen, the jeweler's search will end once the link to the event's website is terminated.

As an important advantage, the presently described website can also be used as a tool by jewelers and others in the jewelry business for obtaining an accurate appraisal (i.e., the wholesale or replacement value) of loose gemstones (e.g., diamonds). That is to say, jewelers will be able to learn the cost one should expect to pay to purchase a gemstone from another jeweler, a vendor, or a customer. To enable the jewelers to obtain a real-time appraisal, and as an important detail of the website, inventory and cost data is uploaded and regularly updated by a variety of dealers (e.g., wholesalers, importers, site holders, buyers, etc.) located around the world. The cost data is provided according to the unique characteristics (e.g., weight or size, shape, color and clarity) and certificate type, if any, of each stone. This data is placed into a database that is stored on the server.

Turning in this regard to FIG. 6 of the drawings, there is shown a representation of the steps by which a jeweler and others in the jewelry business access the website to obtain an appraisal corresponding to the wholesale or replacement value of a gemstone depending upon the aforementioned characteristics thereof. Because the cost data uploaded to the site by others and entered into the database is regularly updated to reflect recent wholesale transactions, the appraisal provided should be reliable.

As described when referring to FIG. 3, a jeweler/requester visiting the website and seeking an appraisal first enters the characteristics 40 of the particular gemstone of interest. For example, it may be necessary for the jeweler/requester to obtain the wholesale cost of a diamond having a weight of 1.43 carats, VS1 clarity, a G color, a pear shape (or cut) and a GIA certification. For search convenience, the cost data uploaded to the site concerning prior transactions is categorized according to weight or size (i.e., carats). That is to say, the cost/characteristics/certificate data for different gemstones is placed into the database stored on the server in the following incremental weight categories:

Gem Weight

```
  .01-.49
  .50-.99
1.00-1.49
1.50-1.99
2.00-2.49
2.50-. . .
```

Therefore, in the present example, once the search is initiated 42, the appraisal is computed from the data collected for all diamonds having a weight lying in a range of weights from 1.00 to 1.49 carats.

In the event that the search of the designated weight category in the database identifies no diamonds having the other characteristics which match the search criteria, a suitable message is displayed 44 to the jeweler/requester and the appraisal search is ended. In this case, there is insufficient data available to provide an appraisal. However, should sufficient data otherwise be available which matches the search field entered by the jeweler/requester, an appraisal is computed from the average of all wholesale prices that are listed in the designated weight category of the database. The average computed price is then multiplied by the actual weight of interest (1.43 in the present case) to achieve the resultant wholesale price. The wholesale price is then displayed to the jeweler/requester adjacent the original search criteria.

The jeweler/requester may click or press an appropriate button (designated 360 in FIG. 3) to receive a printout 48 of the appraisal and the corresponding search criteria (i.e., the gemstone characteristics of interest). Once the appraisal is printed out 52, or if no printout is desired 54, the appraisal search is ended.

1. A method for searching information concerning the jewelry industry by navigating an online, interactive website, said method comprising the steps of:
having those in the jewelry industry upload information to the website concerning gemstones depending upon the characteristics thereof;
storing the uploaded information provided by those in the jewelry industry on a server affiliated with the website;
enabling a jewelry search requester to visit the website and conduct a search of the uploaded information stored on the server with regard to a particular gemstone of interest by entering the characteristics of said gemstone; and
providing a search report when the characteristics of any gemstone whose information is stored on the server matches the characteristics entered by the jewelry search requester for said gemstone of interest.

2. The method for searching information concerning the jewelry industry recited in claim 1, wherein the step of having those in the jewelry industry upload information to the website further includes uploading particular information concerning the source and location of an inventory of gemstones depending upon the characteristics thereof.

3. The method for searching information concerning the jewelry industry recited in claim 2, wherein the step of providing a search result further includes identifying the source and location of any gemstone whose characteristics are stored on the server and which characteristics match the characteristics entered by the jewelry search requester for said gemstone of interest.

4. The method for searching information concerning the jewelry industry recited in claim 3, including the additional step of linking the jewelry search requester through the website to a website of the source of the gemstone identified during said step of providing a search result.

5. The method for searching information concerning the jewelry industry recited in claim 1, wherein the step of having those in the jewelry industry upload information to the website includes uploading particular information concerning the wholesale value of a gemstone previously sold or purchased in the wholesale marketplace depending upon the characteristics thereof.

6. The method for searching information concerning the jewelry industry recited in claim 5, including the additional step of storing on the affiliated server the wholesale values of different gemstones, said wholesale values being grouped in predetermined ranges corresponding to the weights of the gemstones.

7. The method for searching information concerning the jewelry industry recited in claim 6, wherein the step of providing a search result further includes providing the wholesale value of a gemstone of interest whose characteristics entered by the jewelry search requester match the characteristics of other gemstones stored on the server and whose weight falls within the same range of weights as said other gemstones, said wholesale value being calculated by determining an average wholesale value of all of said other gemstones whose weights fall into the same range of weights as said gemstone of interest.

8. The method for searching information concerning the jewelry industry recited in claim 7, wherein the wholesale value of the gemstone of interest is further calculated by the step of multiplying said average wholesale value by the weight of said gemstone of interest.

9. The method for searching information concerning the jewelry industry recited in claim 1, including the additional steps of uploading to the website and storing on the affiliated server information concerning a schedule of events relating to the jewelry industry; and
enabling the jewelry search requester to visit the website and access said schedule of events to retrieve information regarding each event in said schedule.

10. The method for searching information concerning the jewelry industry recited in claim 9, wherein the step of enabling the jewelry search requester to visit the website and access said schedule of events further includes the steps of displaying on the website at least one of a header, an image, or a logo that is indicative of each event from the schedule of events; and linking the jewelry search requester through the website to a website of an organizer or sponsor of the event whose header, image or logo is displayed at the website.
